(19) United States
(12) Patent Application Publication
(10) Pub. No.: US 2018/0052672 A1
(43) Pub. Date: Feb. 22, 2018

(54) PORTABLE STORAGE DEVICE AND METHOD OF INSTALLING OPERATING SYSTEM FROM PORTABLE DEVICE

(71) Applicant: HON HAI PRECISION INDUSTRY CO., LTD., New Taipei (TW)

(72) Inventor: WEN-CHIEH KUO, New Taipei (TW)

(21) Appl. No.: 15/252,243

(22) Filed: Aug. 31, 2016

(30) Foreign Application Priority Data
Aug. 16, 2016 (CN) 201610672311.1

(51) Int. Cl. G06F 9/445; G06F 3/06; G06F 13/42; G06F 9/44

(52) U.S. Cl. CPC G06F 8/61; G06F 3/0604; G06F 3/0644; G06F 2213/0042; G06F 3/0632; G06F 13/4282; G06F 9/4406; G06F 3/0689

(57) ABSTRACT

A portable storage device can install an operating system into and for a bare computer, set multiple disks in the bare computer as a RAID system, and adjust disk partition sizes. The portable storage device includes a storage chip and a control chip. The storage chip is configured to store an operating system program. The control chip includes a detection unit, a setting unit to set at least one hard disk to be a system disk, a writing unit configured to write the operating system program to the system disk, and a switching unit configured to switch the startup option of the bare computer to be the system disk from the portable storage device after the writing unit writes the operating system program to the system disk. An operating system installation method is also provided.

### FIELD

The subject matter herein generally relates to portable storage devices and operating system installation methods.

### BACKGROUND

A portable storage device can be used to install an operating system for a bare computer.

### BRIEF DESCRIPTION OF THE DRAWINGS

Implementations of the present technology will now be described, by way of example only, with reference to the attached figures.

FIG. 1 is a block diagram of one exemplary embodiment of a portable storage device.

FIG. 2 is a flowchart of one exemplary embodiment of an operating system installation method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

The present disclosure is described in relation to a portable storage device and an operating system installation method for a bare computer.

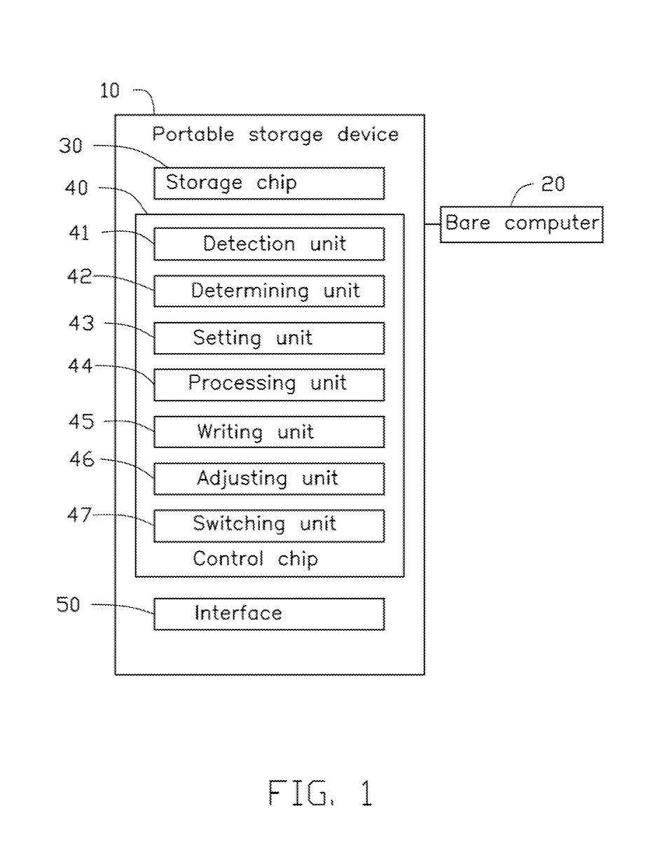

FIG. 1 illustrates an exemplary embodiment of a portable storage device 10. The portable storage device 10 is configured to install an operating system for a bare computer 20. The portable storage device 10 is configured to be connected to the bare computer 20. The portable storage device 10 comprises a storage chip 30, a control chip 40, and an interface 50. The storage chip 30 stores an operating system program. In at least one exemplary embodiment, the bare computer 20 is a server, the interface 50 is a universal serial bus (USB) interface and/or is a serial advanced technology attachment (SATA) interface.

The control chip 40 comprises a detection unit 41, a determining unit 42, a setting unit 43, a processing unit 44, a writing unit 45, an adjusting unit 46, and a switching unit 47.

The bare computer 20 is started by a user. The bare computer 20 is configured to enter a basic input output system (BIOS) interface after the bare computer 20 is powered on. The user sets startup options after the bare computer 20 enters the BIOS interface. The portable storage device 10 is configured to be set to be a first startup option. The bare computer 20 is further configured to be restart after the portable storage device 10 is set to be the first startup option. Thus, the bare computer 20 can be restarted by the portable storage device 10.

The detection unit 41 is configured to detect hard disks of the bare computer 20, and their respective statuses, after the bare computer 20 is restarted by the portable storage device 10. The situation of hard disks of the bare computer 20 includes information as to whether there are usable hard disks in the bare computer 20. The detection unit 41 is also configured to obtain a quantity of usable hard disks of the bare computer 20 after the information confirms usable hard disks in the bare computer 20. The determining unit 42 is configured to determine whether the quantity of usable hard disks of the bare computer 20 is greater than one after the detection unit 41 obtains the quantity of usable hard disks of the bare computer 20. When the quantity of usable hard disks of the bare computer 20 is greater than one, the bare computer 20 displays in order a first hard disk, a second hard disk, a third hard disk, . . . , and an N hard disk. The setting unit 43 is configured to set the first hard disk and the second hard disk to be a system disk if the quantity of usable hard disks of the bare computer 20 is greater than one. The processing unit 44 is configured to set the system disk to be a redundant array of independent disks (RAID) system disk. The setting unit 43 also is configured to set the only hard disk to be the system disk if the quantity of usable hard disks of the bare computer 20 is equal to one.

The writing unit 45 is configured to write the operating system program to the system disk. The adjusting unit 46 is configured to readjust a partition size of the system disk after the writing unit 45 writes the operating system program to the system disk. The switching unit 47 is configured to switch the startup option of the bare computer 20 to be the system disk from the portable storage device 10 after the adjusting unit 46 readjusts the partition size of the system disk. The system disk is configured to finish starting of the bare computer 20 to enable the bare computer 10 to enter a normal working interface of the operating system without being restarted after the switching unit 47 switches the startup option of the bare computer 20 to be the system disk from the portable storage device 10. The portable storage device 10 is configured to be removable from the bare computer 20 after the system disk finishes starting of the bare computer 20.

In one exemplary embodiment, the storage chip 30 also stores application programs, and the writing unit 45 is configured to write the operating system program and the application programs to the system disk.

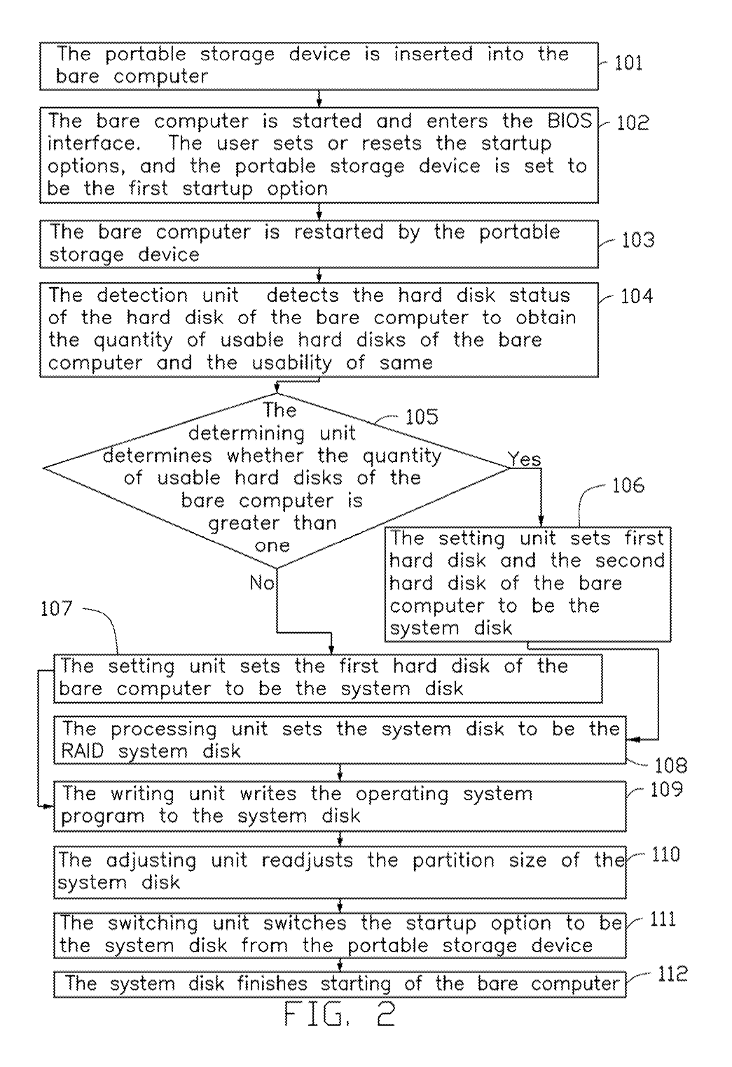

FIG. 2 illustrates a flowchart of a method in accordance with an example embodiment. An operating system installation method is provided by way of example, as there are a variety of ways to carry out the method. The operating system installation method described below can be carried out using the configurations illustrated in FIG. 1, for example, and various elements of these figures are referenced in explaining operating system installation method. The illustrated order of blocks is by example only and the order of the blocks can change. Additional blocks may be added or fewer blocks may be utilized without departing from this disclosure. The operating system installation method can begin at block 101.

At block 101, the portable storage device 10 is inserted into the bare computer 20.

At block 102, the bare computer 20 is started and enters the BIOS interface. The user sets or resets the startup options, and the portable storage device 10 is set to be the first startup option.

At block 103, the bare computer 20 is restarted by the portable storage device 10.

At block 104, the detection unit 41 detects the hard disk status of the bare computer 20 to obtain the quantity of hard disks of the bare computer 20 and the usability of same.

At block 105, the determining unit 42 determines whether the quantity of usable hard disks of the bare computer 20 is greater than one. If yes, the method goes to block 106; if no, the method goes to block 107.

At block 106, the setting unit 43 sets first hard disk and the second hard disk of the bare computer 20 to be the system disk, and the method goes to block 108.

At block 107, the setting unit 43 sets the first hard disk of the bare computer 20 to be the system disk, then the method goes to block 109.

At block 108, the processing unit 44 sets the system disk to be a RAID system disk.

At block 109, the writing unit 45 writes the operating system program to the system disk.

At block 110, the adjusting unit 46 readjusts the partition size of the system disk.

At block 111, the switching unit 47 switches the startup option of the bare computer 20 to be the system disk from the portable storage device 10.

At block 112, the system disk finishes starting of the bare computer 20 to enable the bare computer 10 to enter a normal working interface of the operating system without being restarted.

At block 109, the writing unit 45 writes other application programs together with the operating system program to the system disk when the portable storage device 10 stores other application programs.

At block 110, the adjusting unit 46 readjusts the partition size of the system disk to adjust disk space of the system disk.

At block 112, the portable storage device 10 can be removed from the bare computer 20 after the system disk finishes starting of the bare computer 20. The bare computer 20 can enter a normal working interface of the operating system, thus, the bare computer 20 can be used by a user.

In the exemplary embodiment, the setting unit 43 sets the first and second hard disks of the bare computer 20 to be the system disk if the quantity of usable hard disks of the bare computer 20 is determined to be greater than one, then the processing unit 44 sets the system disk to be a RAID system disk. The writing unit 45 can write the operating system program to the system disk. If one or other of the first and second hard disks is damaged, the remaining hard disk can be used, thereby avoiding non-access to the operating system if one hard disk is damaged.

It is to be understood that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure to the full extent indicated by the broad general meaning of the terms in which the appended claims are expressed.

What is claimed is:

1. A portable storage device configured to install an operating system for a bare computer, comprising:
a storage chip configured to store an operating system program; and
a control chip having:
a detection unit configured to obtain a quantity of usable hard disks of the bare computer after the bare computer is restarted by the portable storage device;
a setting unit configured to set at least one hard disk to be a system disk after the detection unit obtains the quantity of usable hard disks;
a writing unit configured to write the operating system program to the system disk after the setting unit sets at least one hard disk to be the system disk; and
a switching unit configured to switch the startup option of the bare computer to be the system disk from the portable storage device after the writing unit writes the operating system program to the system disk.

2. The portable storage device of claim 1, wherein the control chip further comprises an adjusting unit, the adjusting unit is configured to readjust a partition size of the system disk after the writing unit writes the operating system program to the system disk.

3. The portable storage device of claim 1, wherein the control chip further comprises a determining unit, the determining unit is configured to determine whether the quantity of usable hard disks of the bare computer is greater than one after the detection unit obtains the quantity of usable hard disks of the bare computer.

4. The portable storage device of claim 3, wherein the bare computer orderly displays hard disks after the determining unit determines the quantity of usable hard disks of the bare computer is greater than one, the setting unit is configured to set a first and second hard disks of the bare computer to be the system disk.

5. The portable storage device of claim 4, wherein the control chip further comprises a processing unit, the processing unit is configured to set the first and second hard disks of the bare computer to be a RAID system disk after the setting unit sets the first and second hard disks of the bare computer to be the system disk.

6. The portable storage device of claim 3, wherein the setting unit is configured to set a first hard disk of the bare computer to be the system disk after the determining unit determines the quantity of usable hard disks of the bare computer is equal to one.

7. An operating system installation method comprising:
a bare computer being restarted by a portable storage device;
obtaining a quantity of usable hard disks of the bare computer by a detection unit of the portable storage device;
setting at least one hard disk to be a system disk by a setting unit of the portable storage device;
writing the operating system program to the system disk by a writing unit of the portable storage device; and
a switching unit of the portable storage device switching the startup option of the bare computer to be the system disk from the portable storage device.

8. The operating system installation method of claim 7, further comprising readjusting a partition size of the system disk by an adjusting unit of the portable storage device after writing the operating system program to the system disk by the writing unit.

9. The operating system installation method of claim 7, further comprising determining whether the quantity of usable hard disks of the bare computer is greater than one by a determining unit of the portable storage device.

10. The operating system installation method of claim 9, further comprising setting a first and second hard disks of the bare computer to be the system disk by the setting unit after the determining unit determines the quantity of usable hard disks of the bare computer is greater than one.

11. The portable storage device of claim 10, further comprising setting the first and second hard disks of the bare computer to be a RAID system disk by a processing unit of the portable storage device after the setting unit sets the first and second hard disks of the bare computer to be the system disk.

12. The portable storage device of claim 7, further comprising the portable storage device is set to be the first startup option before the bare computer is restarted by the portable storage device.

13. The portable storage device of claim 7, further comprising the system disk finishes starting of the bare computer to enable the bare computer to enter a normal working interface of the operating system after the switching unit switches the startup option of the bare computer to be the system disk from the portable storage device.

14. An operating system installation method comprising:
setting a portable storage device to be a first startup option;
obtaining a quantity of usable hard disks of a bare computer by a detection unit of the portable storage device;
setting a hard disk to be a system disk by a setting unit of the portable storage device;
writing the operating system program to the system disk by a writing unit of the portable storage device; and
a switching unit of the portable storage device switching the startup option of the bare computer to be the system disk from the portable storage device.

15. The operating system installation method of claim 14, further comprising finishing starting of the bare computer by the system disk to enable the bare computer to enter a normal working interface after the switching unit switches the startup option of the bare computer to be the system disk from the portable storage device.

16. The operating system installation method of claim 14, further comprising the bare computer is restarted by the portable storage device after the portable storage device is set to be the first startup option.

17. The operating system installation method of claim 14, further comprising the bare computer enters a BIOS interface before the portable storage device is set to be the first startup option.

18. The operating system installation method of claim 17, further comprising the portable storage device is inserted into the bare computer before the bare computer enters the BIOS interface.

19. The operating system installation method of claim 14, wherein the portable storage device includes an interface, the interface is a universal serial bus (USB) interface.

20. The operating system installation method of claim 14, further comprising the writing unit writes the operating system program together with other application programs to the system disk when the portable storage device stores application programs.
